(19) United States
(12) Patent Application Publication
(10) Pub. No.: US 2019/0271186 A1
(43) Pub. Date: Sep. 5, 2019

(54) AUTOMATIC DOOR SYSTEM HAVING INTELLIGENT AUTOMATIC IDENTIFICATION

(71) Applicants: LI-PAI CHEN, NEW TAIPEI CITY (TW); RICHARD CHI-HSUEH, SAN DIEGO, CA (US); CHUNG-YEH HSU, NEW TAIPEI CITY (TW)

(72) Inventors: LI-PAI CHEN, NEW TAIPEI CITY (TW); RICHARD CHI-HSUEH, SAN DIEGO, CA (US); CHUNG-YEH HSU, NEW TAIPEI CITY (TW)

(21) Appl. No.: 16/192,955

(22) Filed: Nov. 16, 2018

Related U.S. Application Data
(60) Provisional application No. 62/638,919, filed on Mar. 5, 2018.

(51) Int. Cl. E05F 15/73; E05F 15/619; E05B 47/00; G07C 9/00

(52) U.S. Cl. CPC E05F 15/73; E05F 15/619; E05B 47/00; E05Y 2900/132; E05F 2015/763; E05F 2015/767; G07C 9/00111

(57) ABSTRACT

An automatic door system having intelligent automatic identification is disclosed herein. It comprises a door panel having a lock member actively disposed on a second side thereof for locking a door frame; a central control unit disposed in the door panel and electrically connected to the lock member for controlling extension and contraction of the lock member; a motor power assembly having a motor disposed in the door panel, a gear disposed on a first side of the door panel and driven to rotate by the motor, and a track for assembling to the door frame and correspondingly engaging with the gear; and an intelligent identification system disposed on a first surface of the door panel and electrically connected to the central control unit for identification.

### REFERENCE TO RELATED APPLICATION

This application is based on Provisional Application Ser. No. 62/638,919, filed 5 Mar. 2018, currently pending.

### BACKGROUND OF THE INVENTION

### 1. Field of the Invention

The present invention relates to an automatic door system having intelligent automatic identification which is automatically opened after identifying or confirming a correct user so as to allow the user to pass through the door directly while holding articles in the hand and achieves an effect of increasing practicality in its overall application.

### 2. Description of Related Art

Generally, a door system is locked and unlocked by a mechanical door lock through the key. However, the key has the disadvantages of being easily lost and copied, and the like, resulting in poor security. To solve the disadvantages of the mechanical door lock, automatic identification door locks have been developed to automatically lock and unlock the door by automatically recognizing a specific object. Furthermore, such automatic identification door locks are generally classified into biological identification devices for identifying fingerprint, face, iris, finger, palm, finger veins, palm veins, and the like, and abiotic identification device for identifying cards, magnetic induction, proximity card, natural person certificate, wafer cards, radio frequency identification (RFID), password, and the like.

Although the automatic identification door locks achieve the expected function of locking and unlocking the door by automatically recognizing the specific object, the structure fails to automatically open the door panel after unlocking or automatically close the door panel for locking. In such a case, when the user holds articles in his hand, he needs to place the articles on the ground before opening or closing the door panel, and then lifting the articles. As a result, the structures are greatly inconvenient in actual use and still need to be improved in the overall structural design.

### SUMMARY OF THE INVENTION

In view of the above-mentioned problems, the object of the present invention is to provide an automatic door system having intelligent automatic identification which is automatically opened after identifying or confirming a correct user so as to allow the user to pass through the door directly while holding articles in the hand and achieves an effect of increasing practicality in its overall application.

Disclosed herein is an automatic door system having intelligent automatic identification. It mainly comprises a door panel, a central control unit, a motor power assembly and an intelligent identification system.

The door panel is provided with a pivot part on a first side thereof for pivoting with a door frame and a lock member actively disposed on a second side thereof for locking the door frame.

The central control unit is disposed in the door panel and electrically connected to the lock member of the door panel for controlling extension and contraction of the lock member, and the central control unit is provided with a power supply unit for providing electricity.

The motor power assembly is provided with a motor disposed in the door panel, a gear disposed on the first side of the door panel and driven to rotate by the motor, and a track for assembling to the door frame and correspondingly engaging with the gear.

The intelligent identification system is disposed on a first surface of the door panel and electrically connected to the central control unit for identification.

According to an embodiment of the present invention, the power supply unit of the central control unit is mains electricity or a storage battery.

According to an embodiment of the present invention, the central control unit is further provided with a backup power unit for supplying electricity as the power supply unit does not work, and the backup power unit is a storage battery.

According to an embodiment of the present invention, the central control unit is connected to the Internet for remote monitoring.

According to an embodiment of the present invention, the intelligent identification system includes at least one of an image recognition module, a password identification button, a voice recognition element and a fingerprint recognition element.

According to an embodiment of the present invention, the image recognition module of the intelligent identification system further includes at least one of a pupil recognition element, a face recognition element, a teeth recognition element and an ear recognition element.

According to an embodiment of the present invention, the central control unit is further connected with a sensing module disposed on the first surface of the door panel for sensing if someone is approaching.

According to an embodiment of the present invention, the sensing module includes at least one of an infrared sensing element and a laser sensing element.

According to an embodiment of the present invention, the intelligent identification system includes an image recognition module for video surveillance, and the central control unit is connected to the Internet for remote monitoring by a remote surveillance device.

According to an embodiment of the present invention, the intelligent identification system includes a signal recognition element and is further connected with an artificial intelligence robot having a signal transmitting unit corresponding to the signal recognition element so that the artificial intelligence robot is recognized and allowed by the image recognition module to pass through the door panel.

### BRIEF DESCRIPTION OF THE DRAWINGS

FIG. 1 is a schematic diagram showing an automatic door system having intelligent automatic identification according to the present invention;

FIG. 2 is a stereogram showing an automatic door system having intelligent automatic identification in assembly according to the present invention;

FIG. 3 is a block diagram of a first embodiment for an automatic door system having intelligent automatic identification according to the present invention;

FIG. 4 is a block diagram of a second embodiment for an automatic door system having intelligent automatic identification according to the present invention;

FIG. 5 is a block diagram of a third embodiment for an automatic door system having intelligent automatic identification according to the present invention.

### DETAILED DESCRIPTION OF THE PREFERRED EMBODIMENT

Hereinafter, an exemplary embodiment of the present invention will be described in detail with reference to the accompanying drawings.

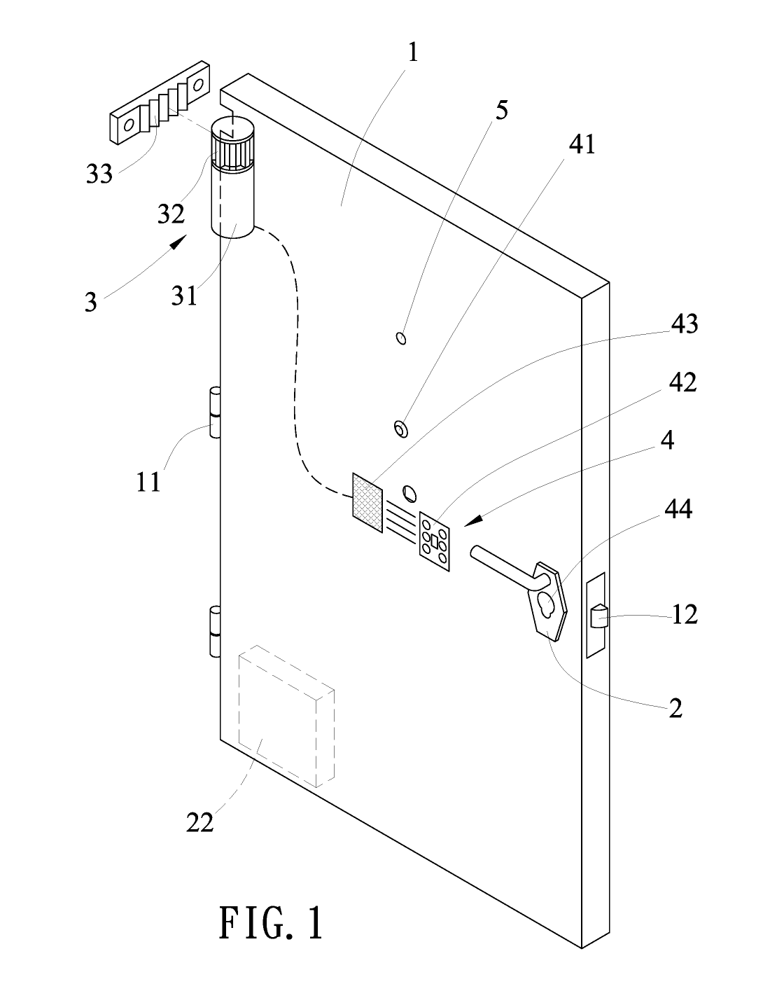

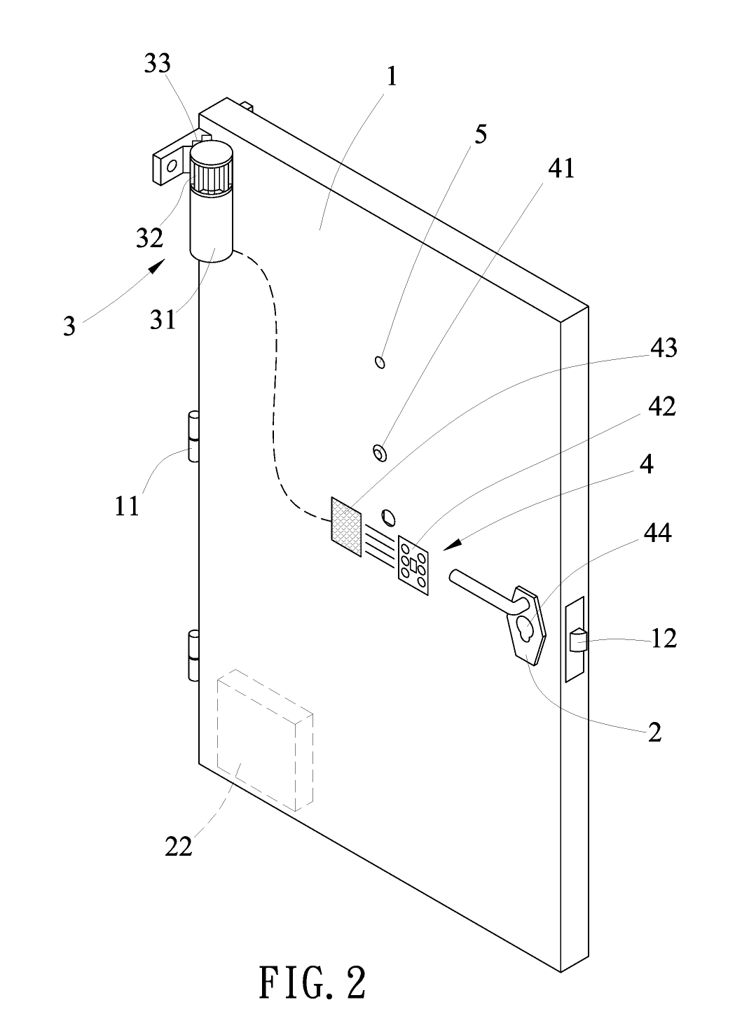

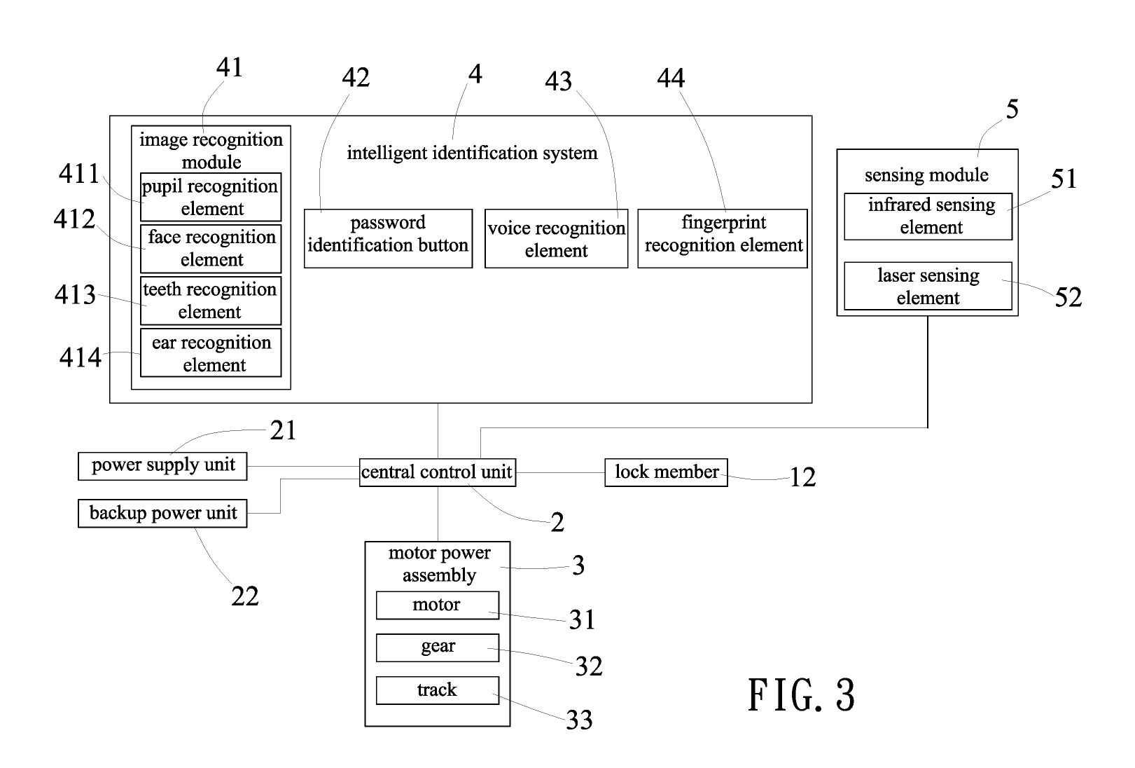

As showed in FIG. 1, FIG. 2 and FIG. 3, an automatic door system having intelligent automatic identification according to the present invention is disclosed herein. It mainly comprises a door panel (1), a central control unit (2), a motor power assembly (3), an intelligent identification system (4), and a sensing module (5).

The door panel (1) has a pivot part (11) on its first side for pivoting with a door frame and a lock member (12) actively disposed on its second side for locking the door frame.

The central control unit (2) is disposed in the door panel (1) and provided with a power supply unit (21) for providing electricity required by the whole automatic door system. Preferably, the power supply unit (21) of the central control unit (2) is mains electricity or a storage battery. The central control unit (2) is also provided with a backup power unit (22) for supplying electricity as the power supply unit (21) does not work. The central control unit (2) is electrically connected to the lock member (12) of the door panel (1) for controlling extension and contraction of the lock member (12). Furthermore, the central control unit (2) is connected to the Internet for remote monitoring.

The motor power assembly (3) has a motor (31) disposed in the door panel (1), a gear (32) disposed on the first side of the door panel (1) and driven to rotate by the motor (31), and a track (33) for assembling to the door frame and correspondingly engaging with the gear (32).

The intelligent identification system (4) is disposed on a first surface of the door panel (1) and electrically connected to the central control unit (2) for identification. Preferably, the intelligent identification system (4) includes at least one of an image recognition module (41), e.g. a camera for identifying the user's image, a password identification button (42), a voice recognition element (43), and a fingerprint recognition element (44). The image recognition module (41) of the intelligent identification system (4) further includes at least one of a pupil recognition element (411), a face recognition element (412), a teeth recognition element (413) and an ear recognition element (414) for respectively identifying the user's pupil image, face image, teeth image, and ear image. The password identification button (42), the voice recognition element (43) and the fingerprint recognition element (44) are for respectively identifying the passwords entered by the user, the user's voices and the user's fingerprints.

The sensing module (5) is further connected to the central control unit (2) and disposed on the first surface of the door panel (1). The sensing module (5) includes at least one of an infrared sensing element (51) and a laser sensing element (52) for sensing if someone is approaching.

In use of the automatic door system having intelligent automatic identification of the present invention, when the user wants to pass the door panel (1), the user's pupil image, face image, teeth image, ear image, voices, fingerprints and the like, or the passwords entered by the user, are identified by the intelligent identification system (4). After the intelligent identification system (4) confirms that the user is correct, or the sensing module (5) senses a correct user is approaching, the intelligent identification system (4) or the sensing module (5) transmits a signal to the central control unit (2) so as to control the contraction of the lock member (12) of the door panel (1) to unlock. At the same time, the central control unit (2) also drives the motor (31) of the motor power assembly (3) to actuate. When the motor (31) rotates, the gear (32) is driven to rotate together. Since the gear (32) is engaged with the track (33) at the door frame, the gear (32) can drive the door plate (1) to open during the rotation in the track (33) thereby allow the user to pass the door panel (1) directly. After the door plate (1) is opened beyond a preset time of the central control unit (2), the central control unit (2) controls the motor (31) of the motor power assembly (3) again to rotate in a reverse direction and then controls the lock member (12) of the door panel (1) to extend outward so as to lock the door panel (1).

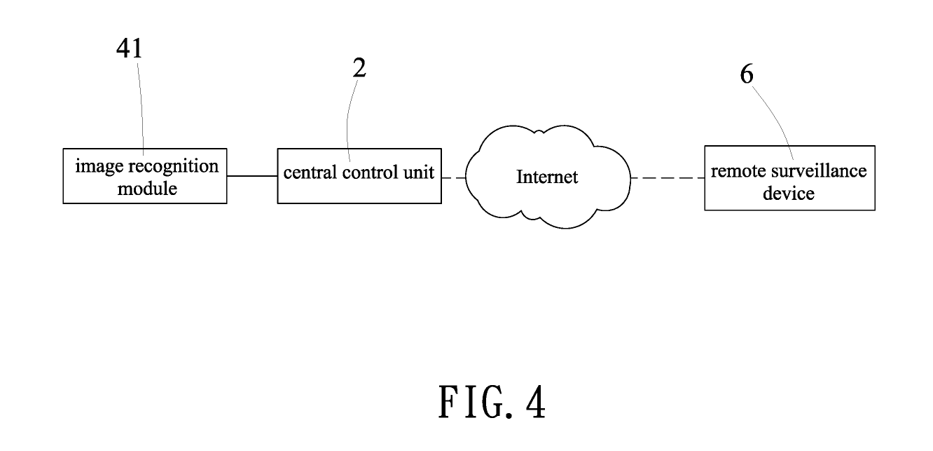

Due to the intelligent identification system (4) being electrically connected to the central control unit (2), the image recognition module (41) of the intelligent identification system (4) which is a camera can be used for video surveillance. After the central control unit (2) is connected to the Internet by wire or wirelessly, the user can use a remote surveillance device (6), e.g. smart mobile devices or fixed devices, for remote monitoring and operation as shown in FIG. 4.

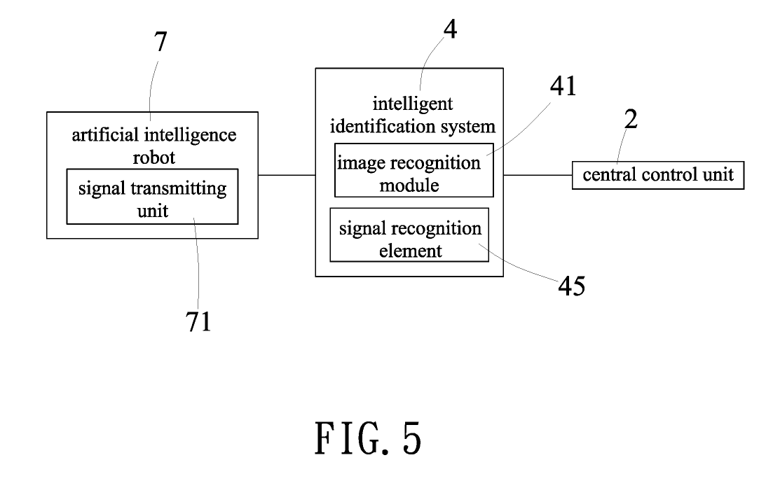

Referring to FIG. 5, the intelligent identification system (4) includes a signal recognition element (45) and further connected with an artificial intelligence robot (7) having a signal transmitting unit (71) corresponding to the signal recognition element (45) so that the artificial intelligence robot (7) is recognized and allowed by the image recognition module (41) of the intelligent identification system (4) to pass through the door panel (1). A signal transmitted by the signal transmitting unit (71) of the artificial intelligence robot (7) can also be recognized by the signal recognition element (45). If the signal recognition element (45) identifies a correct signal, the intelligent identification system (4) also transmits a signal to the central control unit (2) so as to control the contraction of the lock member (12) of the door panel (1) to unlock. At the same time, the central control unit (2) also drives the motor (31) of the motor power assembly (3) to actuate. When the motor (31) rotates, the gear (32) is driven to rotate together. Since the gear (32) is engaged with the track (33) at the door frame, the gear (32) can drive the door plate (1) to open during the rotation in the track (33) thereby allow the artificial intelligence robot (7) to pass the door panel (1) directly. After the door plate (1) is opened beyond a preset time of the central control unit (2), the central control unit (2) controls the motor (31) of the motor power assembly (3) again to rotate in a reverse direction and then controls the lock member (12) of the door panel (1) to extend outward so as to lock the door panel (1).

Compared with the technique available now, the present invention can be automatically opened without pushing by the hand after identifying or confirming the correct user, so the user is allowed to pass through the door directly while holding articles in the hand. Accordingly, the present invention achieves an effect of increasing practicality in its overall application.

What is claimed is:

1. An automatic door system having intelligent automatic identification, comprising:
a door panel having a pivot part on a first side thereof for pivoting with a door frame and a lock member actively disposed on a second side thereof for locking the door frame;
a central control unit disposed in the door panel and electrically connected to the lock member of the door panel for controlling extension and contraction of the lock member, wherein the central control unit is provided with a power supply unit for providing electricity;
a motor power assembly having a motor disposed in the door panel, a gear disposed on the first side of the door panel and driven to rotate by the motor, and a track for assembling to the door frame and correspondingly engaging with the gear; and
an intelligent identification system disposed on a first surface of the door panel and electrically connected to the central control unit for identification.

2. The automatic door system having intelligent automatic identification as claimed in claim 1, wherein the power supply unit of the central control unit is mains electricity or a storage battery.

3. The automatic door system having intelligent automatic identification as claimed in claim 1, wherein the central control unit is further provided with a backup power unit for supplying electricity as the power supply unit does not work, and wherein the backup power unit is a storage battery.

4. The automatic door system having intelligent automatic identification as claimed in claim 1, wherein the central control unit is connected to the Internet for remote monitoring.

5. The automatic door system having intelligent automatic identification as claimed in claim 1, wherein the intelligent identification system includes at least one of an image recognition module, a password identification button, a voice recognition element and a fingerprint recognition element.

6. The automatic door system having intelligent automatic identification as claimed in claim 1, wherein the image recognition module of the intelligent identification system further includes at least one of a pupil recognition element, a face recognition element, a teeth recognition element and an ear recognition element.

7. The automatic door system having intelligent automatic identification as claimed in claim 1, wherein the central control unit is further connected with a sensing module disposed on the first surface of the door panel for sensing if someone is approaching.

8. The automatic door system having intelligent automatic identification as claimed in claim 7, wherein the sensing module includes at least one of an infrared sensing element and a laser sensing element.

9. The automatic door system having intelligent automatic identification as claimed in claim 1, wherein the intelligent identification system includes an image recognition module for video surveillance, and the central control unit is connected to the Internet for remote monitoring by a remote surveillance device.

10. The automatic door system having intelligent automatic identification as claimed in claim 1, wherein the intelligent identification system includes a signal recognition element and is further connected with an artificial intelligence robot having a signal transmitting unit corresponding to the signal recognition element so that the artificial intelligence robot is recognized and allowed by the image recognition module to pass through the door panel.
